(19) United States
(12) Patent Application Publication
(10) Pub. No.: US 2010/0236175 A1
(43) Pub. Date: Sep. 23, 2010

(54) MULTI-COLORED SNAP-LOCK SIDING PANEL, AND SYSTEM AND METHOD FOR MAKING THE SAME

(75) Inventor: Daniel W. King, Copely, OH (US)

Correspondence Address: HOWARD & HOWARD ATTORNEYS PLLC, 450 West Fourth Street, Royal Oak, MI, 48067, US

(73) Assignee: TAPCO INTERNATIONAL CORPORATION, Wixom, MI (US)

(21) Appl. No.: 12/726,153

(22) Filed: Mar. 17, 2010

Related U.S. Application Data
(60) Provisional application No. 61/290,838, filed on Dec. 29, 2009.
(60) Provisional application No. 61/160,927, filed on Mar. 17, 2009.
(60) Provisional application No. 61/290,383, filed on Dec. 28, 2009.

(51) Int. Cl. B44F 9/00; E04C 2/38; B05C 11/02; B05D 5/06

(52) U.S. Cl. 52/314; 52/519; 118/123; 427/267

(57) ABSTRACT

A siding system including interlocking panels for installation on a support surface. Each panel has opposing top and bottom edges, and adjacent panels are interlocking at least one location between their top and bottom edges. The panels are supported by projections extending from their rear faces against movement toward the support surface when installed. The panels simulate an arranged plurality of individual building elements such as bricks or stones, and have a variegated appearance. A system for creating the panels is also provided that includes a conveyance by which a panel is conveyed through a plurality of coating stations at which a plurality of different coatings are applied. The plurality of applicators are configured to dispense at least two different coatings onto the panels as the panels move along the conveyor. The panels with patterns of different coatings applied is then conveyed to a wiping station at which the patterns of applied coating patterns are smeared to achieve a variegated appearance as a wiping or blending device spreads and mixes or blends the plurality different coatings onto the decorative face of the panels. The panels are then conducted through a curing station wherein the smeared coating is cured. A method for making the panels is also provided. The method includes dispensing at least two different coatings onto the panels and blending the coatings together on the panels to give the panels an variegated appearance simulating building elements such as brick or stone.

### CROSS-REFERENCE TO RELATED APPLICATIONS

This application claims priority to U.S. Provisional Applications Nos. 61/160,927 filed Mar. 17, 2009, and 61/290,383, filed Dec. 28, 2009. This application also is related to co-pending U.S. application Ser. No. 12/188,349, filed Aug. 8, 2008, entitled “PANEL FOR USE IN A SIDING SYSTEM FOR PROVIDING A DECORATIVE COVERING ON A SUPPORT SURFACE”, and co-pending U.S. application Ser. No. 11/539,822, filed Oct. 9, 2006, entitled “SYSTEM AND METHOD FOR MAKING DECORATIVE BUILDING PANELS HAVING A VARIEGATED APPEARANCE”, the disclosures of which are incorporated herein by reference.

### FIELD OF THE INVENTION

The present invention relates to a siding system, panels of the siding system, and a method for making the panels to provide a decorative covering on a support surface such as on a wall of a building.

### BACKGROUND OF THE INVENTION

There are various known methods of covering, protecting, and decorating an exterior surface of a building. For example, construction of brick or stone against the exterior surface of a building is popular with consumers. However, the construction using individual brick or the stone building elements can be expensive when compared to other conventional methods.

Siding systems have been used for decades as an alternative to brick or stone construction. Generally, siding systems are less expensive to construct than the brick or the stone. Typically, the siding systems include a plurality of panels with the panels disposed adjacent to one another for covering the support surface of the building.

Additionally, it is known in the art to include a decorative element, such as a patterned face that may resemble an arranged plurality of individual building elements such as bricks or stones, on the panels for aesthetic purposes. However, the siding systems of the prior art do not employ suitable interlocking mechanisms for holding adjacent panels together to resemble a brick or stone face. Similarly, the panels of the prior art do not employ a system for decorating the panels with two or more coatings that are blended or mixed together to provide an appearance resembling brick or stone, particularly weathered or aged brick or stone.

### SUMMARY OF THE INVENTION AND ADVANTAGES

A siding system is provided including at least one panel used to cover a support surface. The panel has a body having opposing top and bottom edges and defining a plane. The panel also has a first locking element coupled to the top edge of the body for engaging with a second, adjacent panel. The panel further includes a second locking element mounted to the bottom edge of the body.

The present invention provides a siding system for use in covering a support surface, including at least one panel having opposed decorative and rear faces, the decorative face defined by a plurality of decorative elements simulating an arranged plurality of individual building elements, and channels located between and defining adjacent decorative elements of the panel. The decorative elements have smeared coatings defining variegated colors thereon, and the channels are substantially devoid of smeared coatings.

A system for creating the panel is also provided that includes a conveyor for moving panels. A plurality of applicators is configured to dispense at least two different coatings onto the panels as the panels move along the conveyor. A blending device is disposed downstream of the applicators to spread and mix the at least two different coatings onto the panels.

The present invention provides a system for decorating a siding panel with coatings of variegated color to simulate an arranged plurality of individual building elements, including at least one conveyance on which the panel is conducted in a first direction, and a plurality of coating stations through which the panel is conducted. Each coating station has an applicator that is moved in a second direction other than the first direction. Coating patterns of differing colors are applied by the applicators onto a decorative face of the panel as the panel is moved through the coating stations. A blending station is located downstream of the coating stations and includes at least one wiper. The panel is conducted through the blending station, and the wiper moved in a third direction other than the first direction while in sliding contact with the decorative face of the panel as the panel is moved through the blending station. The plurality of coatings applied to the panel is smeared, mixed and distributed over raised portions of the panel decorative face by the wiper, by which the smeared coatings variegate the appearance of the panel decorative surface. A curing station is provided through which the panel is conducted and at which the smeared coating is cured.

A method for making the panel is also provided. The method includes dispensing the at least two different coatings onto the panel and blending the coatings together on the panel to give the panel a highly desirable brick or stone appearance.

The present invention provides a method for providing a variegated appearance on the decorative face of a siding panel, including the steps of: moving the panel along a first direction sequentially through a plurality of coating stations; applying one of a plurality of different coatings to the decorative face at each coating station with an applicator as the panel is moved along the first direction; moving the respective applicator at each coating station in a direction different from the first direction while it is applying its coating to the decorative face, whereby different coatings are applied in a plurality of patterns on the panel; wiping the decorative face with a first wiper that is moving in a direction different from the first direction while moving the panel in the first direction, and smearing the applied coating patterns over surfaces of a plurality of raised decorative elements of the decorative face defined by grooves therebetween, thereby variegating the coating thereon with the first wiper; maintaining the first wiper substantially out of contact with portions of the decorative face located in the grooves, whereby coating disposed in the grooves is not smeared by the first wiper; and curing the smeared coatings distributed on the decorative elements.

### BRIEF DESCRIPTION OF THE DRAWINGS

To accomplish the above and related objects, the invention may be embodied in the forms illustrated in the accompanying drawings, attention being called to the fact, however, that the drawings are illustrative only, and that changes may be made in the specific constructions illustrated. Moreover, it is to be noted that the accompanying drawings are not necessarily drawn to scale or to the same scale. In particular, the scale of some of the elements of the drawings may be exaggerated to emphasize characteristics of the elements. Other advantages of the present invention will be readily appreciated, as the same becomes better understood by reference to the following detailed description when considered in connection with the accompanying drawings wherein:

FIG. 1A is a front elevation of a dwelling having a first embodiment siding system simulating an arranged plurality of individual natural stone building elements attached to an exterior support surface thereof;

FIG. 1B is a front elevation of a dwelling having a second embodiment siding system simulating an arranged plurality of individual brick building elements attached to an exterior support surface thereof;

FIG. 2 is a fragmented, front view of a first siding panel of the first embodiment siding system fixed to the support surface and spaced from a third panel of the siding system prior to disposing the third panel over the first panel, the first and third panels positioned vertically above a fourth panel of the siding system that has been previously installed on the support surface;

FIG. 3 is a fragmented, front view of the third panel now overlapping the first panel and fixed to the support surface, and a second panel of the siding system disposed vertically above the first panel and fixed to the support surface;

FIG. 4A is a partial front perspective view of the first panel illustrating a tab pocket of the first panel and a tab of the second panel inserted in the tab pocket;

FIG. 4B is a partial front perspective view of the first panel illustrating a bottom edge of the first panel and a cutout in the bottom edge to facilitate receiving the third panel;

FIG. 5 is a rear perspective view of a panel of the first embodiment;

FIG. 6 is a front perspective view of a first panel of the second embodiment siding system spaced from a third panel of the siding system prior to disposing the third panel over the first panel;

FIG. 7 is a left end view of a panel of the second embodiment;

FIG. 8 is a front perspective, cross-sectional view of the first and second panels of the first embodiment siding system;

FIG. 9 is a fragmented cross-sectional side view of the first and second panels of FIG. 8;

FIGS. 10A-10C are fragmented cross-sectional side views illustrating the sequence of interlocking the first and second panels;

FIG. 11 is an elevational view of a processing system for making the panels;

FIG. 12 is a top schematic view illustrating dispensing of three different coatings on the panels and wiping of the dispensed coatings;

FIG. 13A is a front perspective, broken view of a coating booth of the processing system shown in FIG. 11;

FIG. 13B is an enlarged, fragmented sectional view of the air knife in the coating booth of FIG. 13A;

FIG. 14 is a perspective view looking downstream, of an embodiment of the wiping station of the processing system shown in FIG. 11; and

FIG. 15 is a perspective view looking upstream, of an embodiment of the wiping station of the processing system shown in FIG. 11.

### DETAILED DESCRIPTION OF THE INVENTION

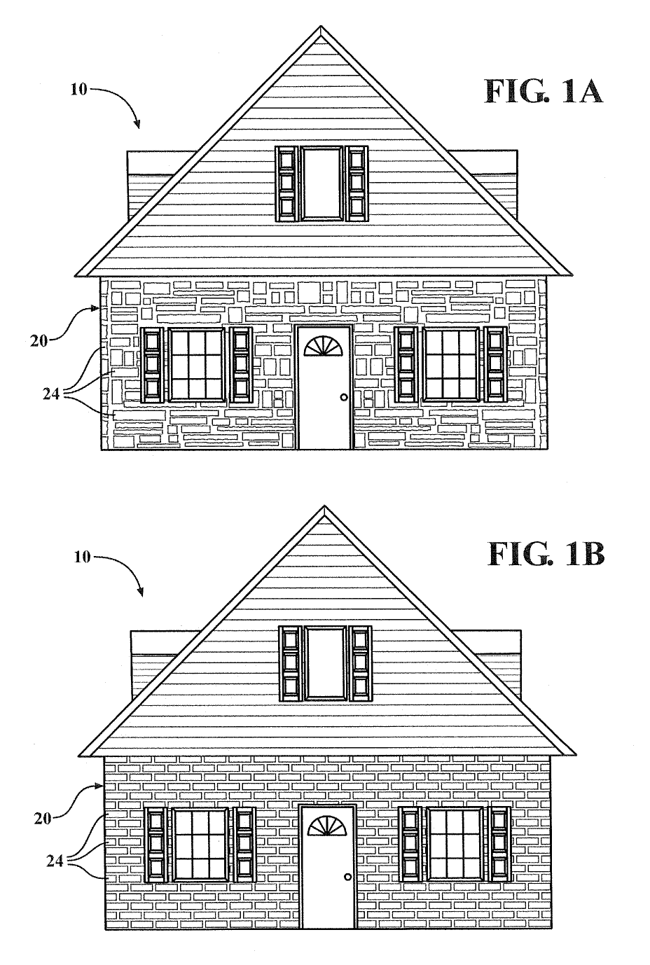

Referring to the Figures, wherein like numerals indicate like or corresponding parts throughout the several views, a siding system 20 for covering a support surface 22 is shown. Siding system 20 defines a substantially planar surface that simulates the appearance of an arranged plurality of individual building elements such as stones and/or bricks. FIG. 1A shows a first embodiment siding system that simulates a natural stone wall. FIG. 1B shows a second embodiment siding system that simulates a brick wall. The simulated arrangements of pluralities of individual stone and brick building elements exemplified by the depicted embodiments are illustrative only, and not intended to limit the invention simulating only these building materials. Generally, the siding system 20 may be disposed on at least one exterior wall of a building 10 or the like. However, it is to be appreciated that the siding system 20 may be disposed on other surfaces, such as at least one interior wall or at least one interior ceiling of the building.

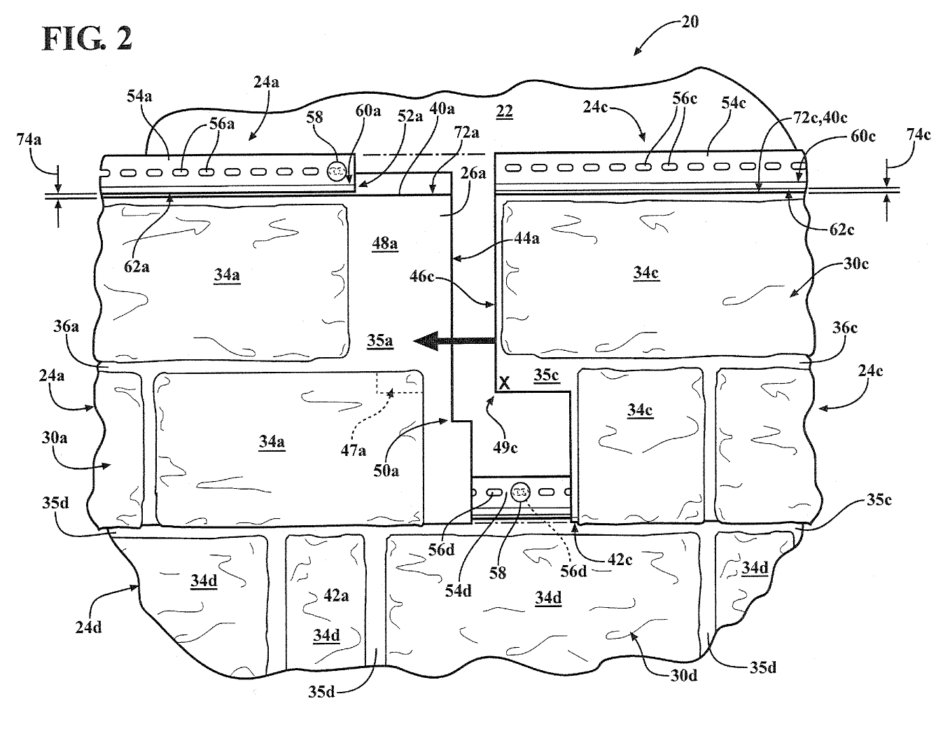

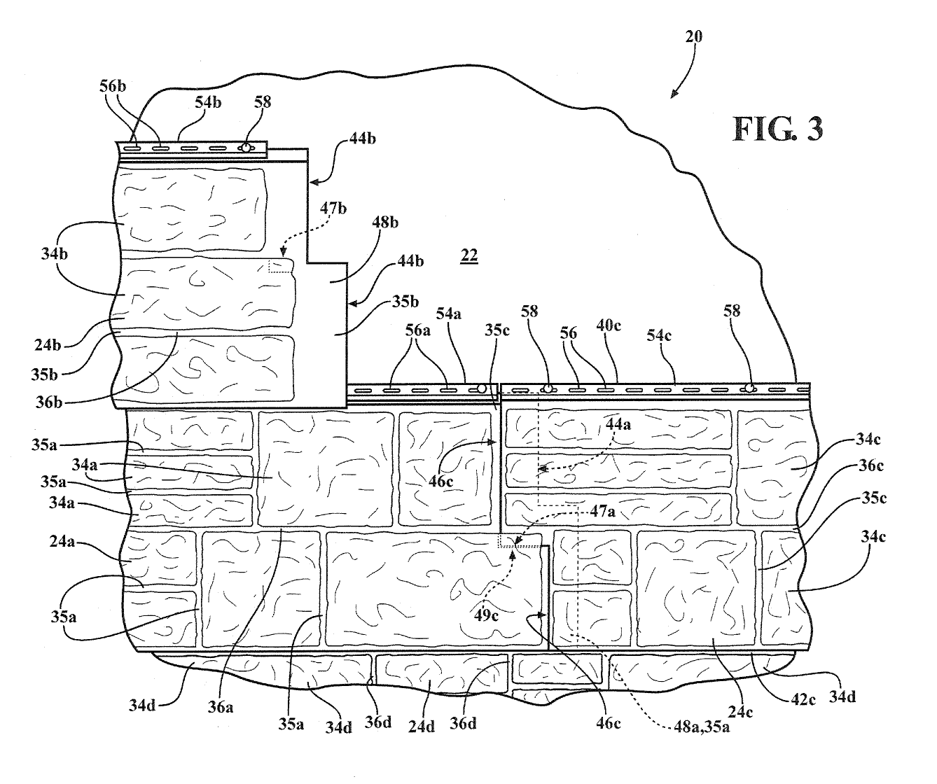

The siding system 20 includes a plurality of panels 24. In FIGS. 2 and 3, four panels 24 are shown (designated first 24a, second 24b, third 24c, and fourth 24d panels for descriptive purposes). Typically, each panel 24 comprises a rigid thermoplastic material, such as polyvinylchloride or “vinyl” however, it is to be appreciated that the panel 24 may comprise other suitable materials without departing from the nature of the present invention. Generally, each panel 24 is integrally formed such that the panel 24 is a unitary sheet of the rigid thermoplastic material having a generally uniform thickness.

Referring to FIGS. 2-5, the panel 24 presents a decorative face 30 opposed by a rear face 32 such that the rear face 32 is adjacent to the support surface 22 when the panel 24 is installed, i.e., when it is mounted to the support surface 22. The decorative face 30 defines a plurality of decorative elements 34 that cooperate to resemble brick or stone such that together they resemble staggered rows of bricks or stone. However, it is to be appreciated that the decorative elements 34 may simulate other building materials, such as shake shingle siding. Typically, the decorative elements 34 are raised from a recessed surface 35 of the panel 24 such that the decorative elements 34 adjacent to each other define a channel 36 therebetween. The channels 36 are configured to resemble grout or mortar lines, which are known in the art of brick or stone wall construction.

It should be appreciated that each of the panels 24 may have the same decorative elements 34. However, there are preferably several panels 24 with differing numbers and sizes of decorative elements 34 to better resemble brick or stone construction, the latter is often characterized by stones that are somewhat non-uniform in appearance. The following description refers to panels 24a, 24b, 24c, and 24d, however, relative to a respective brick or stone-simulating embodiment, each of these panels has the same features as they are identical in all respects, except for potential differences in decorative appearance dictated by the decorative elements 34. Reference numerals herein may have a suffix a, b, c, or d indicative of the depicted one of panels 24a-d.

The panel body 26 has opposing top and bottom edges 40, 42. The panel 24 further includes a right end 44 and a left end 46. The terms top, bottom, left and right are used herein for exemplary purposes and are not intended to be limiting.

Referring to FIG. 2, panel 24 further includes an overlapping portion 48 at the right end 44. As shown in FIG. 2, it is to be appreciated that the overlapping portion 48 may define a first cutout 50 to give the overlapping portion 48 a staggered appearance. The panel also has a tab pocket 47 extending beneath a decorative element 34 adjacent the recessed surface 35, the tab pocket having an opening in the periphery of the adjacent decorative element. The pocket is partly defined by the recessed surface 35 of the panel 24 and by a part of the periphery of the adjacent decorative element 34. Panel 24 also has a corresponding tab 49 at the left end 46 that slides into the tab pocket 47 when overlying the left end 46 of one panel 24 (e.g., 24c) on the overlapping portion 48 of another panel 24 (e.g., 24a). The tab 49 and tap pocket 47 cooperate to positively interlock the horizontally adjacent panels 24a, 24c together in a direction away from the support surface 22, at least one location intermediate top and bottom edges 40, 42; that is, the interlocked panels are interlocked against substantive relative movement in directions normal to recessed surface 35. In the preferred embodiment, the tab 49 (indicated with an “X” in FIG. 2) is simply a formed extension of the planar recessed surface 35 of the panel 24.

FIG. 2 shows the overlapping portion 48 of one of the panels 24 (designated first panel 24a) being exposed and adjacent to a left end 46 of an adjacent panel (designated third panel 24c). FIG. 3 shows the left end 46 of the third panel 24c overlying the overlapping portion 48 of the first panel 24a. When they are assembled, some of the decorative elements 34 of each of the panels 24 cooperate to define the channels 36 resembling the mortar line.

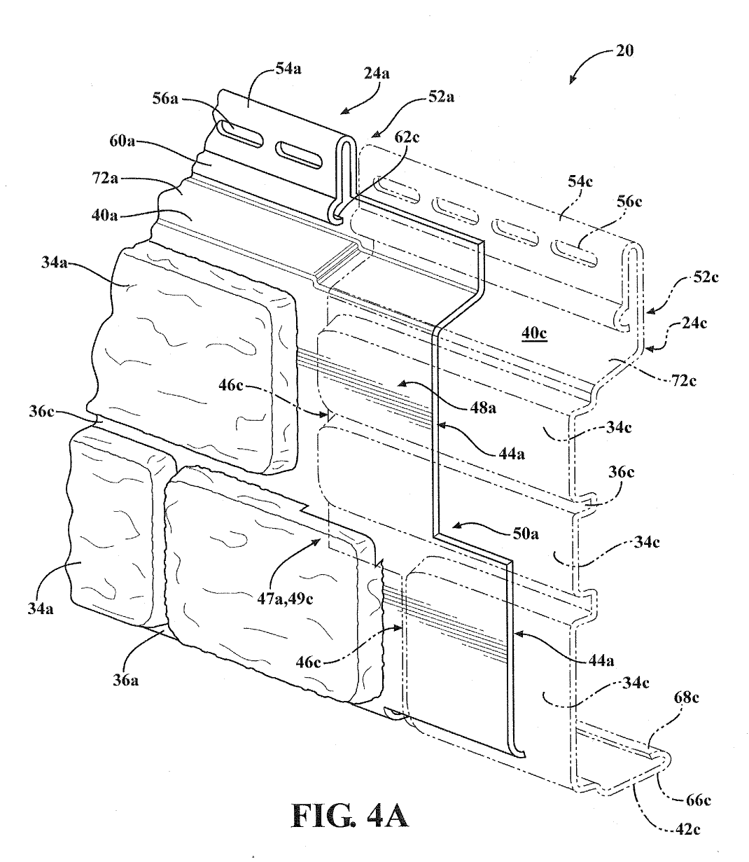

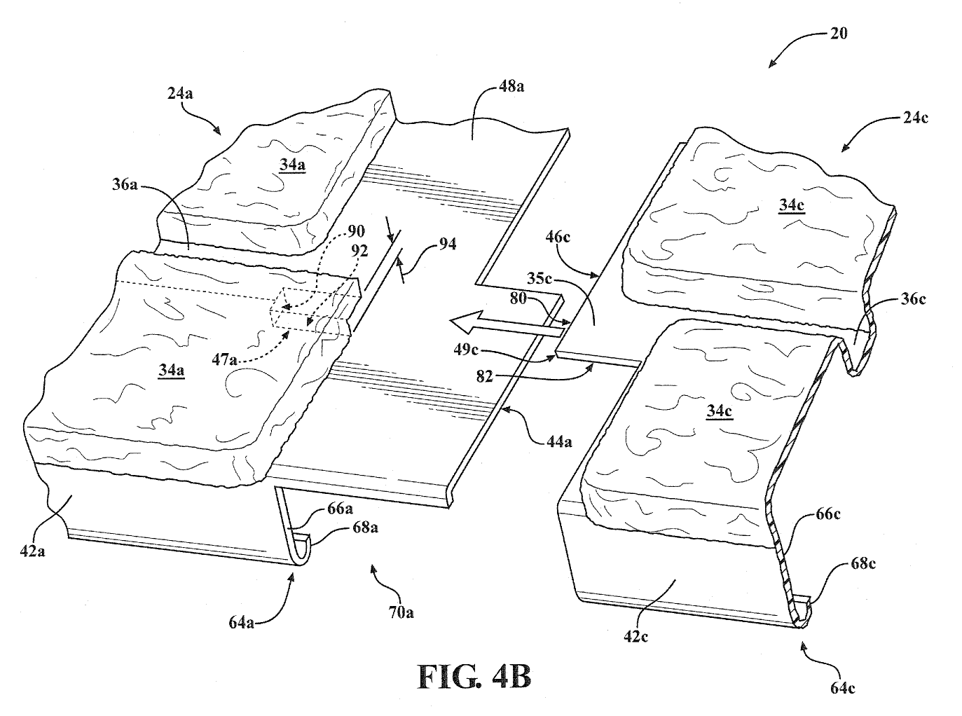

Referring to FIGS. 4A and 4B, overlapping of the panels 24a, 24c side-by-side is shown in more detail. In FIG. 4A, the tab 49 of the third panel 24c slides into the tab pocket 47 of the first panel 24a when overlying the left end 46 of the third panel 24c on the overlapping portion 48 of the first panel 24a. The tab 49 locks the third panel 24c to the first panel 24a in an outward direction. FIG. 4B shows how the first 24a and third panels 24c fit together at the bottom edge 42. Preferably, the two adjacent edges 80, 82 defining tab 49 respectively abut corresponding edges 90, 92 defining pocket 47 to relatively position panels 24a, 24c. Height 94 of pocket 47 is slightly greater than the material thickness of the portion of panel 24 defining recessed surface 35, which defines tab 49.

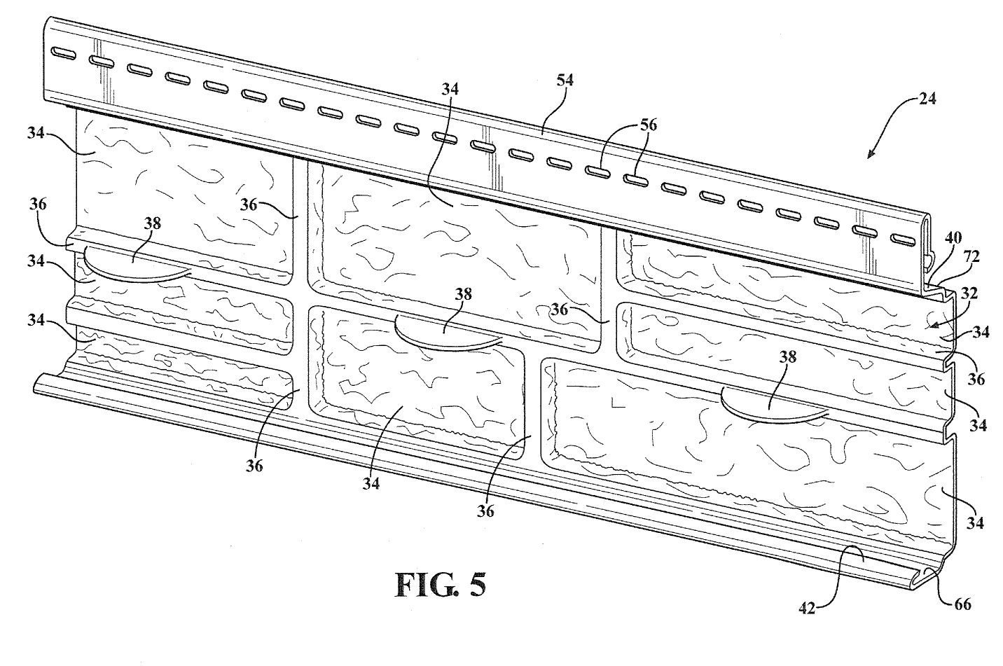

Referring specifically to FIG. 5, the panel 24 includes a plurality of projections or ears 38 disposed on and extending from the rear face 32 such that the projections 38 are disposed between the decorative face 30 of panel 24, and the support surface 22, when the panel 24 is installed. This provides added rigidity to the panel 24 and spacing between the panel 24 and the support surface 22, and supports the panel against an inwardly deflecting force. Preferably, ears 38 are integrally formed on panel rear face 32; and are positioned on the reverse side of groove channels 36 and extend longitudinally therealong, as illustrated.

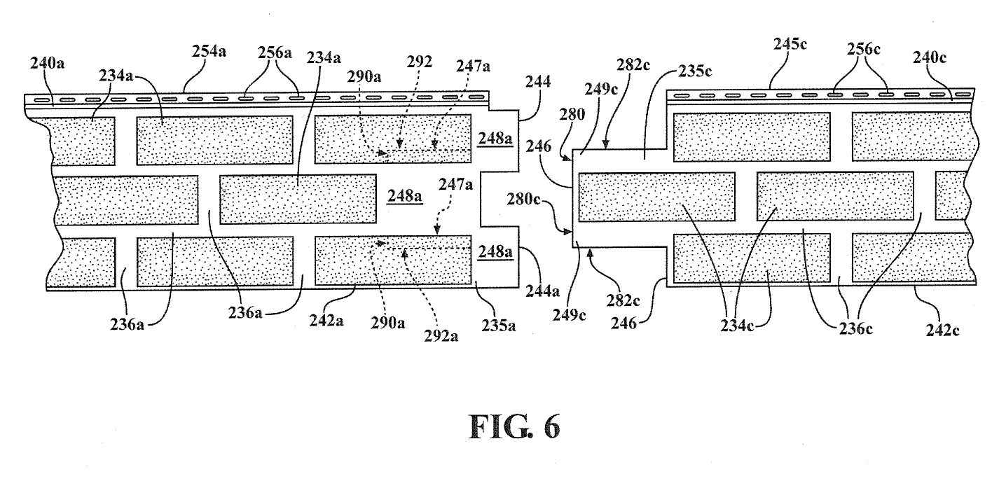

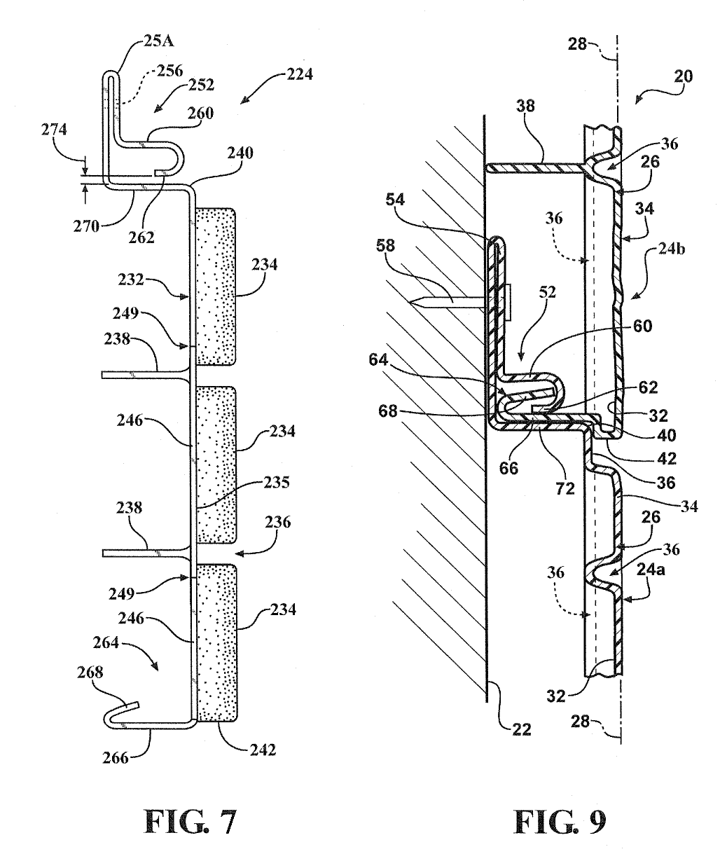

Referring to FIGS. 6 and 7, first panel 224a and third panel 224c of the second embodiment are shown. In this embodiment, panels 224 are created to resemble brick, while panels 24 of the first embodiment are created to resemble natural stone. Elements of the second embodiment corresponding to elements of the first embodiment are indicated with the corresponding first embodiment reference numeral having the prefix 2, and second embodiment elements may have a suffix indicative of the depicted one of panels 224a-b. In the second embodiment, the right end 244 of each panel 224 (e.g., 224a) has overlapping portions 248 and a pair of tab pockets 247 for receiving a pair of tabs 249 located at the left end 246 of the horizontally adjacent panel 224 (e.g., 224c). Of course, it should be understood that, like the other embodiments, each of the panels are configured similarly so that both panels 224a and 224c have overlapping portions 248, a pair of tab pockets 247, and a pair of tabs 249. Each panel 224 also has projections 238, decorative elements 234, channels 236, and top and bottom edges 240, 242 similar to stone panels 24. Except as particularly noted, references herein to panel 24 shall be interpreted as referring also to alternative panel 224.

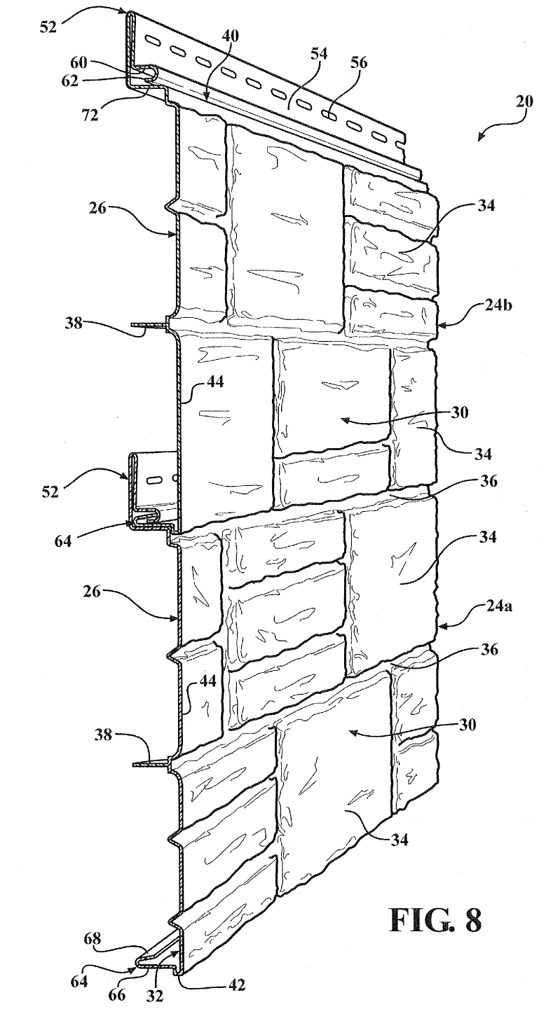

Referring to FIGS. 8 and 9, each of the panels 24 has a first locking element generally shown at 52. The first locking element 52 is coupled to the top edge 40. The first locking element 52 presents a nailing hem 54. The nailing hem 54 of the first locking element 52 is offset from a plane 28 (see FIG. 9) and defines a plurality of holes 56 for receiving a plurality of fasteners 58 (see FIG. 9) to secure the panel 24 to the support surface 22. The nailing hem 54 is formed by folding the rigid thermoplastic material back on itself thereby doubling the thickness of the panel 24 at the nailing hem 54. However, a single layer of the rigid thermoplastic material may form the nailing hem 54. The holes 56 may be horizontally elongated for increasing the installation area of the fasteners 58 to the support surface 22 and for allowing the thermal expansion of the panel 24 without causing the panel 24 to buckle.

Referring specifically to FIG. 9, the first locking element 52 also includes a first arm 60 having a length and disposed between and transverse to the plane 28 and the nailing hem 54. The first arm 60 has a first finger 62 such that the first arm 60 and the first finger 62 cooperate to present a general hook-shaped configuration. The first arm 60 has a normal position and a biased position, which will be discussed in detail below.

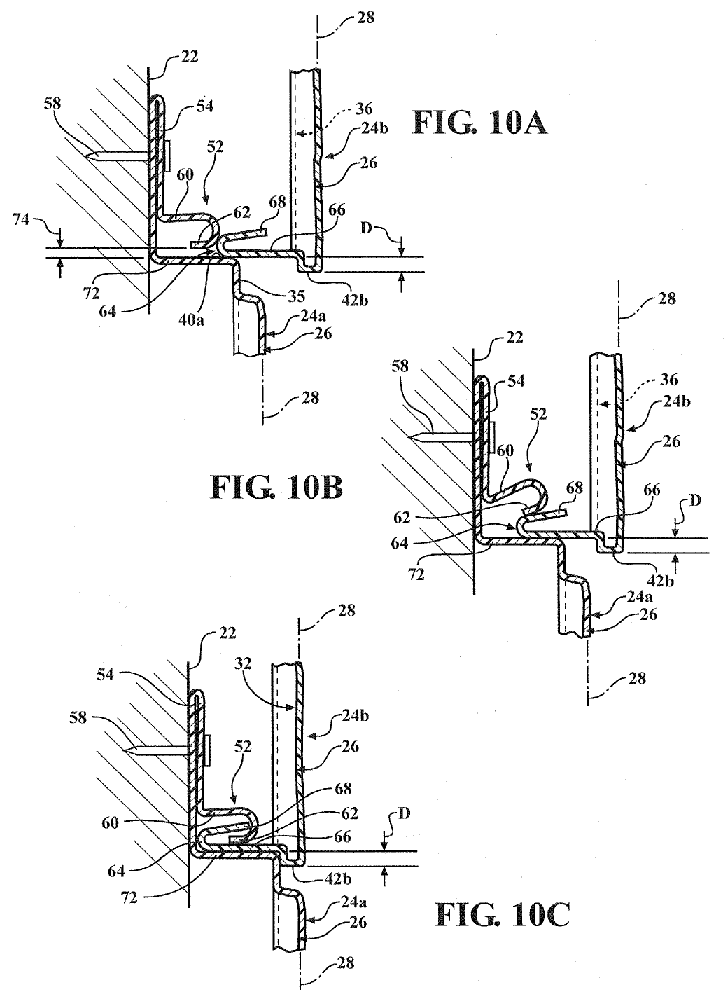

The panel 24 further includes a second locking element generally shown at 64 in the Figures. The second locking element 64 has a length and is mounted to the bottom edge 42 for spacing the bottom edge 42 from the support surface 22. The second locking element 64 is transverse to the plane 28 and extends from the rear face 32 of the panel 24. The second locking element 64 has a second arm 66 having a second finger 68 with the second arm 66 and the second finger 68 cooperating to present a complementary configuration to the first arm 60 and the first finger 62. Said differently, the second arm 66 and the second finger 68 together present a general hook-shaped configuration that complements the general hook-shaped configuration of the first arm 60 and the first finger 62. Typically, the second arm 66 is spaced a distance D from the bottom edge 42 of the panel 24 as shown in FIGS. 10A-10C. However, the second arm 66 may be aligned with the bottom edge 42 of the panel 24 without deviating from the subject invention. Referring to FIG. 4B, the second locking element 64 may define a second cut out 70 adjacent to the right end 44 which will be discussed in detail below.

The first locking element 52 and the second locking element 64 are continuous along the horizontal length of panel 24. However, it is to be appreciated that the panel 24 may instead have a plurality of first locking elements 52 spaced from each other along the horizontal length of panel 24 or a plurality of second locking elements 64 spaced from each other along the horizontal length of panel 24 such that one or more of second locking elements 64 vertically align with one or more first locking elements 52, between vertically adjacent panels 24 (e.g., between panels 24a and 24b).

The panel 24 also includes a horizontally extending, planar spacer 72 interconnecting the first locking element 52 and the recessed surface 35 for spacing the top edge 40 of the body 26 from the support surface 22 such that the plane 28 is substantially parallel with the support surface 22. It is to be appreciated that the term “substantially parallel” as used herein is an approximation and the plane 28 is considered to be substantially parallel to the support surface 22 when the panels 24 present an appearance of a straight wall. For example, in the embodiments shown in the Figures, the plane 28 is substantially parallel to the support surface 22 to present an appearance of a brick or stone wall.

The spacer 72 has a length that is complementary to the length of the second locking element 64 such that the combined spacing provided by the spacer 72 and the second locking element 64 results in the plane 28 of the panel 24 being parallel to the support surface 22. Typically, the length of the spacer 72 is greater than the length of the first arm 60 of the first locking element 52 for recessing the first arm 60 relative to the plane 28. The first locking element 52 and the spacer 72 define a gap 74 therebetween. It is to be appreciated that the first locking element 52 may contact the spacer 72 while still defining the gap 74.

As shown in FIG. 10A, the first panel 24a is mounted to the support surface 22 and subsequently the second locking element 64 of the second panel 24b is aligned with the gap 74 of the first panel 24a. As shown in FIG. 10B, the second locking element 64 of the second panel 24b is disposed within the gap 74 of the first panel 24a by applying a force to the bottom edge 42 of the second panel 24b. The second locking element 64 of the second panel 24b contacts and deflects the first locking element 52 of the first panel 24a, and elastically deforms the first arm 60 from its normal position to a biased position, to allow the second locking element 64 of the second panel 24b to pass beneath first finger 62 and become interengaged with the first locking element 52 of the first panel 24a for interlocking the panels 24.

Referring to FIG. 10C, after the second finger 68 of the second locking element 64 passes the first finger 62 of the first locking element 52, the elastically deflected first arm 60 returns to its normal position, wherein first finger 62 is positioned below second finger 68, thereby resulting in the interlocking of the first finger 62 with the second finger 68. It is to be appreciated that the first locking element 52 may remain in a position between the normal position and the biased position, instead of returning to its normal position, once the first locking element 52 and the second locking element 64 interlock. It is also to be appreciated that the panels 24 may be interlocked by other methods known in the art, such as sliding the second locking element 64 of the second panel 24b within the first locking element 52 of the first panel 24a.

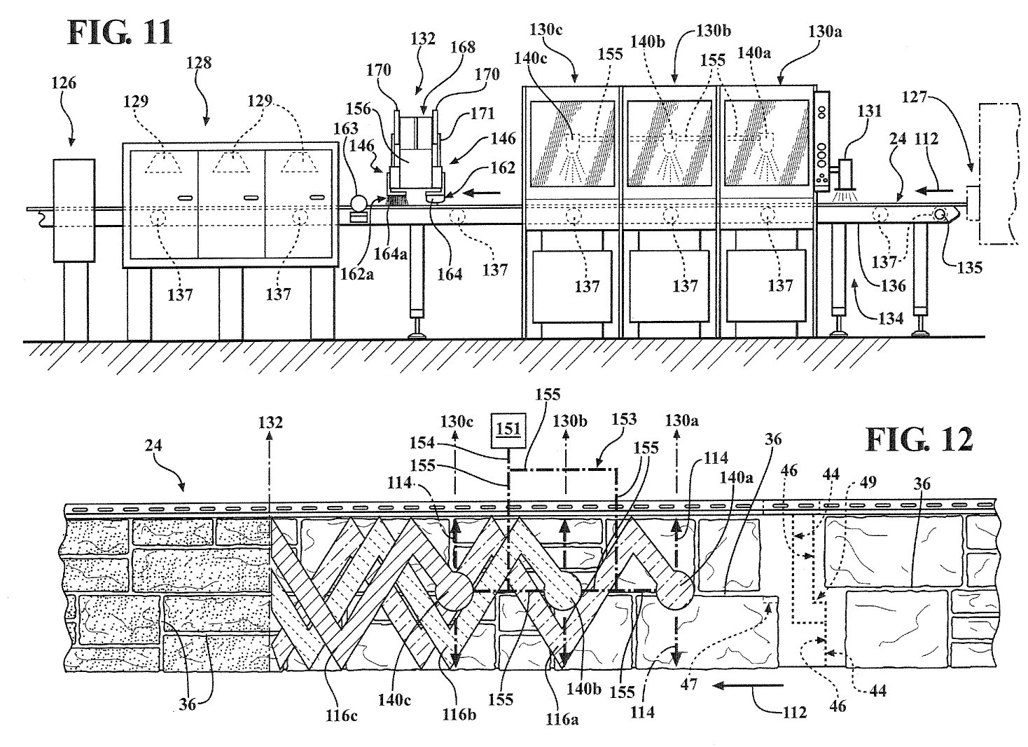

Referring to FIG. 11, a system 110 for decorating the panels 24 is shown through which the panels move continuously in the direction of arrow 112. The system 110 includes a plurality of coating stations 130 (130a, 130b, 130c), a wiping or blending station 132, and a curing station 128. It is to be appreciated that the coating stations 130, the wiping station 132, and the curing station 128 could be used to decorate previously formed panels 24 from inventory that are fed, one at a time, into the system 110, or, alternatively, a continuous panel of the thermoplastic material could enter the system 110 as it is formed, prior to being cut into shorter, individual panels 24, possibly along the dashed lines shown in FIG. 12, corresponding to panel ends 44, 46. In the latter case, the continuous panel of thermoplastic material would enter the system 110 from an exit section 127 (see FIG. 11) of a continuous panel forming system (not shown). The continuous panel forming system and process may be like that shown in U.S. Pat. No. 7,008,213 to King, hereby incorporated by reference, or any other suitable continuous panel forming system or process. The term “sheet of thermoplastic material” as used in the description and the claims can refer to either an individual panel 24 previously formed or a continuous panel of thermoplastic material. For simplicity, the system and methods of the present invention will be described with reference to decorating previously formed, individual panels.

A conveyor 134 feeds the panels 24 through the system 110. The conveyor 134 may be any conventional conveying system suitable for moving the panels 24 between and through the coating stations 130, the wiping station 132, and the curing station 128. For instance, the conveyor 134 may include a conveyor belt 136 supported by a plurality of rollers 137 with at least one of the rollers 137 being rotated by a suitable motor 135 to drive the conveyor belt 136 in a conventional manner. The conveyor 134 moves the panels 24 through the system 110 at a rate of from about one to about 100 feet per minute, more preferably from about 25 to about 60 feet per minute, and most preferably at about 50 feet per minute. In one embodiment, a plurality of conveyors 134 are used in the system 110 to provide separation between adjacent panels 24 as they pass through the system 110. For instance, separate conveyors 134 may: (1) feed the panels 24 into the coating stations 130; (2) move the panels 24 out from the coating stations 130 and to the wiping station 132; (3) move the panels 24 from the wiping station 132 to the curing station 128; and (4) move the panels 24 out of the curing station 128. Each of the conveyors 134 moves slightly faster than the last to create a gap of separation between sequentially processed panels 24.

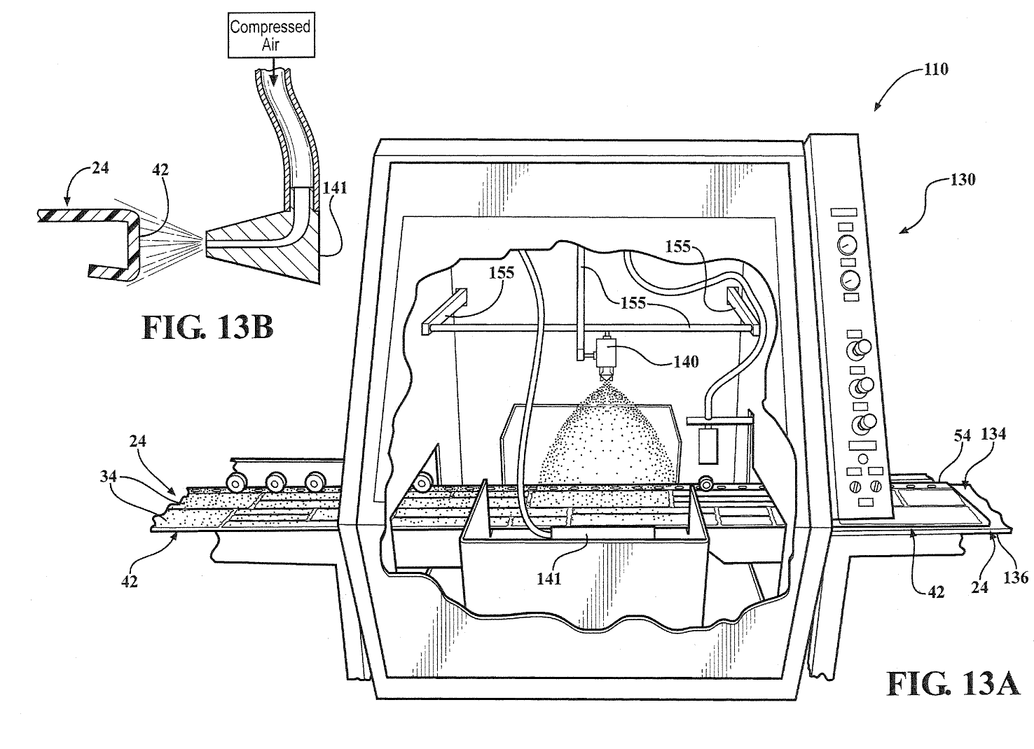

Prior to the panel 24 entering the coating stations 130, an anti-static device 131 may be employed to remove areas of isolated static charge on the panel 24 that may attract paint to varying degrees. The anti-static device 131 may be an air knife or other suitable device. This provides a more uniform coating spread. At each of the coating stations 130, one of which is shown in FIG. 13A, an applicator 140 (e.g., a nozzle) applies a coating onto the surface of the panel 24. Preferably, two or more coating stations 130 are employed to apply two different coatings to the panels 24. The coatings may differ by having a different pigment or color. More preferably, three coating stations 130 are employed to apply three different colored coatings. Three coating stations 130a, 130b, 130c respectively having respective nozzles 140a, 140b, 140c, are shown in FIG. 11. Each of the three different colored coatings dispensed by nozzles 140 is represented by one of three distinguishable spray patterns 116a, 116b, 116c in FIG. 12. Nozzles 140 move back and forth laterally relative to panel 24, and the different spray patterns 116 overlap each other as panel 24 progresses through the multiple coating stations 130, as shown in FIG. 12.

An air knife 141 is optionally mounted in the painting station 30 to direct a fluid stream, preferably a compressed air stream, toward the bottom edge 42 of panel 24, as best shown in FIG. 13B. The air stream deflects particles of the paint from the applicator 40 toward the bottom edge 42 to deposit the paint thereon such that the variegated appearance can be provided on bottom edge 42. The air knife 141 operates using principles well known to those skilled in the art and will not be described in detail.

Preferably, each of the colors of the two or three coatings is different than the color of the thermoplastic material so that the “mortar lines” between the decorative elements are better defined. The coatings are applied directly above the decorative elements 34 of the panels 24. The coatings generally cover the decorative elements 34, but do not completely fill in the channels 36. As a result, less coating material fills in the simulated mortar lines 36. Because the mortar lines 36 are recessed, being located at the level of panel recessed surface 35 in the depicted embodiments, it is also more difficult for the coatings to access this area. For this reason, the color of the thermoplastic material is preferably gray or off-white, or any color that resembles the color of mortar, since the base color of the panels 24 will largely dictate the color of the mortar lines 36 in the finished product.

Preferably, the coatings are ultra-violet (UV) curable paints. The term color includes any color (including black and white), hue, shade, or combination thereof, which may be provided by the addition of any natural or synthetic coloring agents, pigments, and the like. The term color also includes multi-colored paint or multi-colored thermoplastic materials. Ceramic microspheres are preferably added to one or more of the coatings prior to application. The microspheres add texture to the coatings to give the panels 24 a more rugged, stone or brick appearance. The microspheres also reduce the gloss of the coatings. One type of microsphere that can be used is 3M White Ceramic Microspheres, grades W-210, W-410, or W-610.

Referring to FIGS. 11 and 12, an actuator 151 (e.g., motor, hydraulic cylinder, etc.) reciprocates the applicators 140 back and forth laterally across the panels 24. The actuator 151 is coupled to a support structure 153 that reciprocates upon actuation of the actuator 151. The support structure 153 is fixed to the applicators 140 and supports each of the applicators 140. As the actuator 151 operates, the support structure reciprocates back and forth across the width of the panels 24. The support structure 153 may comprises a plurality of rigid support arms 155 disposed between each of the applicators 140 and coupled to an arm 154 of the actuator 151. Since the panels 24 are moving longitudinally with the conveyor belt 136, as indicated by arrow 112, while the applicators 140 reciprocate laterally back and forth in the directions indicated by arrows 114, each of the coatings is applied in a generally sinusoidal wave, as indicated by the shapes of patterns 116. When three coatings are applied as shown in FIG. 12, three sinusoidal waves of different coatings, e.g., colors, are applied to the panels 24.

From furthest downstream coating station 130c, the panel 24 (or a given longitudinal position on the panel 24) passes through the wiping station 132 before the paint is cured. The panel 24 moves in a longitudinal direction indicated by arrow 112 with the conveyor belt 136, through the wiping or blending station 132, at which the coatings of the three spray patterns 116a-c dispensed on panel 24 are blended and distributed over its decorative face 30.

The wiping station 132 includes a pair of wipers or blending devices 162, 162a that are sequentially encountered and move back and forth across the panel 24 in a lateral directions indicated by arrow 120 to displace the paint across decorative elements 34, which are preferably textured to simulate natural stone or brick surfaces. Paint applied in channels 36 remains substantially untouched by wipers 162, 162a, which promotes the variegated appearance of the panel, for the channels are substantially devoid of the smeared coatings distributed on decorative elements 34.

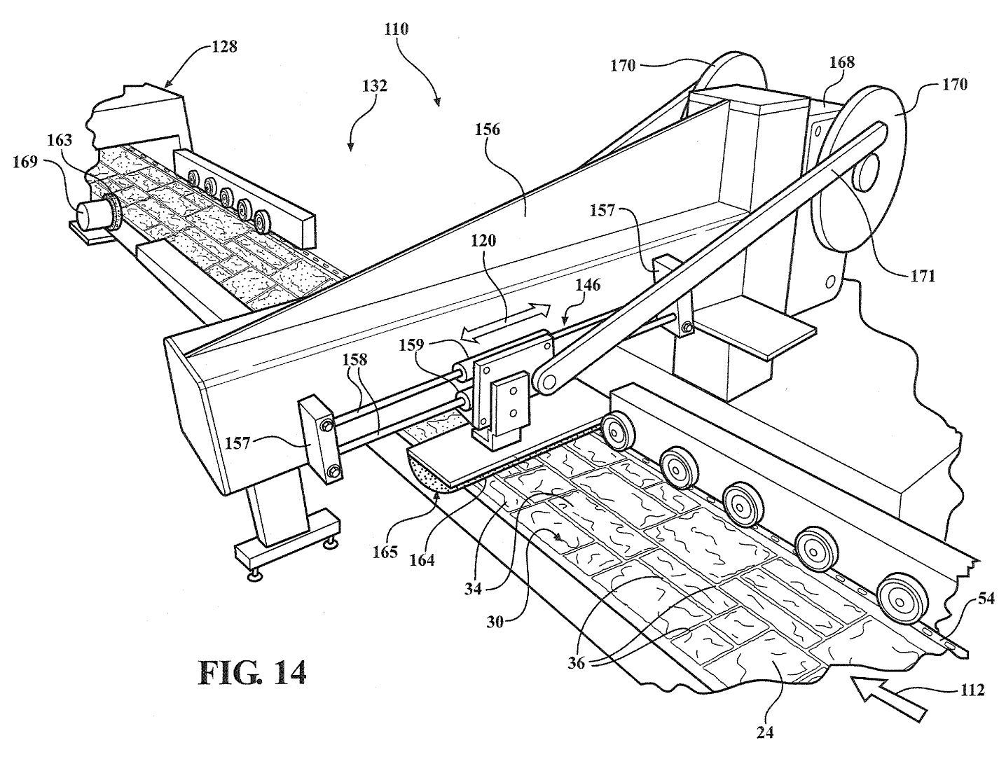

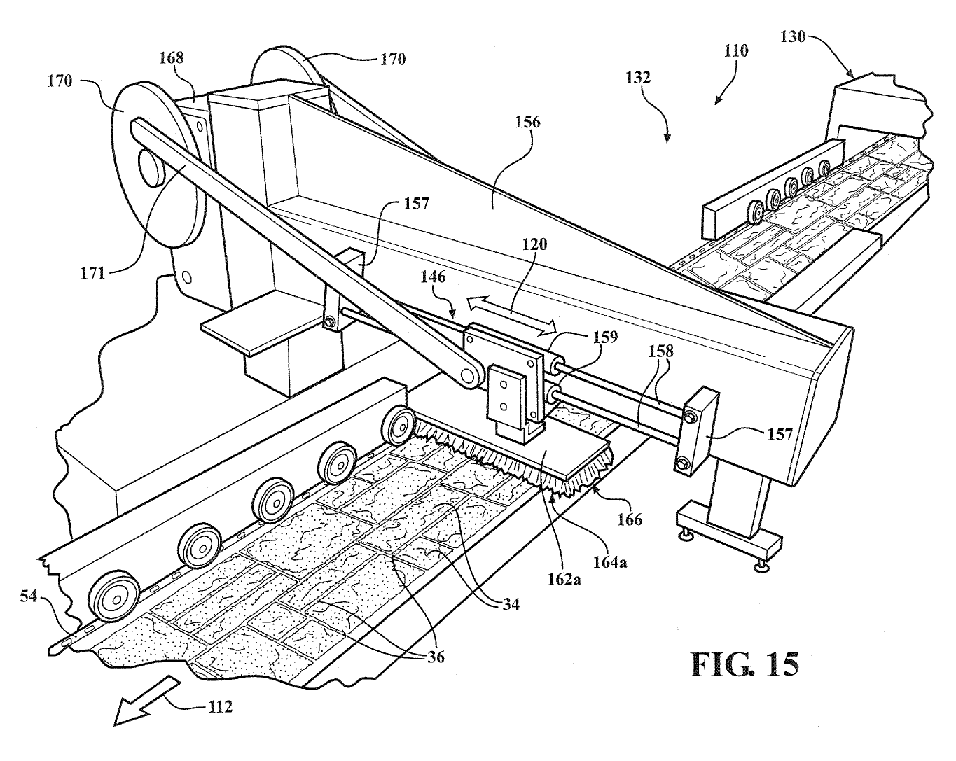

Wiping station 132 has support structure 156 that straddles the conveyor belt 136 to support the wipers 162, 162a. In FIG. 14, the right or upstream side of the support structure 156 is shown with right side wiper 162. In FIG. 15, the left or downstream side of the support structure 156 is shown with left side wiper 162a. The driving components of wiping station 132 for the right and left side wipers 162, 162a are mirrored on the opposite upstream and downstream sides of support structure 156. Each side of support structure 156 includes a pair of brackets 157 extending from the side of the support structure 156 to carry a pair of rod-shaped tracks 158 that extend laterally across the conveyor belt 36. A mounting assembly 146 is slidably supported on each pair of rod-shaped tracks 158 by a pair of cylindrical bushings 159. Each wiper 162, 162a is fixed to its respective mounting assembly 146. An electric motor 168 is used to drive the mounting assemblies 146 back and forth across the panel 24. Drive wheels 170 located on opposite sides of support structure 156 are turned by the electric motor 168, while a link 171 pivotally attaches each drive wheel 170 to its respective mounting assembly 146 such that rotation of the drive wheel 170 drives the mounting assembly 146 back and forth along the tracks 158. Preferably, the same electric motor 68 drives both the right and left side drive wheels 170, which are 180° out of phase with each other.

The tracks 158 at the wiping station 132 are generally parallel with the surface of the panel 24, such that the wipers 162, 162a remain in contact with the face 30 as the wipers 162, 162a move in the lateral direction indicated by arrows 120 across the panels 24. In some embodiments, the wipers 162, 162a may travel an inclined path because the bottom edge 42 of the panel 24 is generally higher than the nail hem 24. However, the panel 24 is preferably positioned on the conveyor belt 36 such that the surface of panel decorative face 30 defined by elements 34 is substantially horizontal and the wiping station 132 is not inclined.

At the preferred conveyor belt speed of about 50 feet per minute, the right and left side wipers 162, 162a, respectively, preferably move back and forth at a cycle rate of about one second, or about one stroke every one half second. One stroke refers to one wiper 162, 162a moving between the ends of its lateral range of motion in one of the two directions indicated by arrow 120. Thus, one back and forth motion cycle of one wiper 162, 162a would equal two strokes, i.e., each wiper 162, 162a operates on a two-stroke cycle. It is expected that the cycle rate of the wiping station would increase with increased conveyor speed, and slow with decreased conveyor speed. Notably, system 110 may be configured to drive wipers 162, 162a at cycle rates that differ from each other, through appropriate gear reduction or separate motors 168, for example.

In the preferred embodiment, the wipers 162, 162a positioned on the opposite, right and left sides of the support structure 156 move in opposite directions to provide better wiping and balance inertia at the wiping station 132. In other words, when the right side wiper 162 is at the end of its forward stroke, the left side wiper 162a is at the end of its back stroke.

Preferably, the wipers 162, 162a are elongate and at all times extend completely across the width of panel 24. In other words, the lengths of wipers 162, 162a are greater than the lateral width of panel 24, and wipers 162, 162a, superpose the entire width of panel 24 throughout their wiping cycles. The wipers 162, 162a move transversely in the directions indicated by arrow 120, i.e., laterally, to the longitudinal movement of the panel 24 in the direction indicated by arrow 112 through the wiping station 132.

The wipers 162, 162a may each include a non-absorbent, resilient pad 164 having lower surface 165 that contacts the faces of decorative elements 34 of the panel 24. The non-absorbent pad 164 mixes and smears the coatings across the decorative elements 34, without substantially touching the paint applied in the grooves 36. One type of preferred pad 164 is formed from a silicone foam rubber. However, similar materials having low absorption could also be used. In some instances, carpet pads may be used to smear the paint. It should be appreciated that the pads 164 actually smear the paint, and move it from higher areas on elements 34 toward lower areas thereon, and into grooves 36. Pad 164 is preferably flexible and is compressed on the higher areas such that parts of the pad surface 165 contacts portions of the sides of the higher areas of elements 34s, rendering the variegated appearance more authentic. A weight or resilient member such as a leaf spring can be used to hold pad 164 against face 30 of panel 24 to facilitate blending and/or smearing of the coatings on the panel. Elongated pad 164 may be biased into contact with panel 24 as disclosed in U.S. application Ser. No. 11/539,822, which uses biasing members such as leaf springs to apply variable pressure to the panels with its pads. The coatings smear together along the decorative elements 34 of the panels 24, yet generally do not fill in channels 36 defining the mortar lines to create a mortar appearance on the panel 24.

Downstream blending device 162a may include a similar pad 164 of flexible foam silicone, but preferably takes the form of a soft-bristled brush that at all times superposes the entire transverse or lateral width of panel 24, as downstream wiper 162a reciprocates. As shown in FIG. 15, brush 164a has bristles 166 that are in contact panel 24, and further smear or blend the paint previously smeared or blended by upstream blending device 162.

An optional secondary wiper 163 in the form of a rotating brush or rotating pad 163 of non-absorbent material may be rotatably mounted to a motor 169 on a side of the conveyor 34 downstream of wiping station 132, as shown in FIG. 14. The rotating brush 163, if included, smears the paint applied along the bottom edge 42 of panel 24 to ensure that the variegated appearance is also present thereon. The rotating brush 163 may be disposed at an acute angle to edge 24 such that the rotating brush 163 contacts bottom edge 42 along an outside corner thereof.

Referring back to FIG. 11, once the panels 24 pass through the wiping or blending station 132 or 132a (and are past optional secondary wiper 163) the panels 24 are cured at the curing station 128. Depending upon the type of coating utilized, the curing station 128 may include heaters, blowers, or UV light sources. In the preferred embodiment, the coating that is applied to the panel 24 is a UV curable paint and the curing station 128 includes a UV light source 129, such as a plurality of UV lights 129. The panel 24 is exposed to the UV light source 129 for a sufficient amount of time to cure the paint, such as for 10 seconds. The conveyor 134 feeds the panel 24 through the curing station 128 and the panel 24 exits the curing station to be stacked or to be cut at the cutting station 126, in the event a continuous panel is being decorated.

While the invention has been described with reference to an exemplary embodiment, it will be understood by those skilled in the art that various changes may be made and equivalents may be substituted for elements thereof without departing from the scope of the invention. Therefore, it is intended that the invention not be limited to the particular embodiment disclosed as the best mode contemplated for carrying out this invention, but that the invention will include all embodiments falling within the scope of the appended claims.

What is claimed is:

1. A siding system for use in covering a support surface, comprising:
at least one panel having opposed decorative and rear faces, said decorative face defined by a plurality of decorative elements simulating an arranged plurality of individual building elements; and
channels located between and defining adjacent decorative elements of said panel,
wherein said decorative elements have smeared coatings defining variegated colors thereon, said channels substantially devoid of smeared coatings.

2. The siding system of claim 1, wherein said panel comprises:
a top edge and a bottom edge between which is located said decorative face;
a spacer extending in a direction away from said rear face and disposed along one of said edges; and
a plurality of projections disposed between said top and bottom edges and extending from said rear face;
wherein said panel is adapted for installation on the support surface and to which said panel is attachable, said spacer and projections disposed between said decorative face of the installed panel and the support surface.

3. The siding system of claim 2, wherein said decorative elements have surfaces that substantially lie in a plane, said plane substantially parallel to the support surface and said decorative face supported against movement toward the support surface by said projections when said panel is installed.

4. The siding system of claim 3, wherein a said projection is disposed on a reverse side of a said channel.

5. The siding system of claim 1, wherein said panel defines a recessed surface opposite said rear face which is devoid of said decorative elements and is adjacent to a said decorative element, said panel having a pocket extending beneath said adjacent decorative element, said pocket partially defined by a portion of the periphery of said adjacent decorative element and said recessed surface, said panel defining a first panel, and further comprising:
a second said panel adjacent to said first panel, said second panel having an end overlappingly receivable onto said recessed surface of said first panel, said end having a tab defined thereon that is receivable in said pocket, said tab when received in said pocket being captured beneath said adjacent decorative element of said first panel, whereby said first and second panels are positively interlocked against substantive relative movement in directions normal to said recessed surface.

6. A system for decorating a siding panel with coatings of variegated color to simulate an arranged plurality of individual building elements, comprising:
at least one conveyance on which the panel is conducted in a first direction;
a plurality of coating stations through which the panel is conducted, each said coating station having an applicator that is moved in a second direction other than the first direction, coating patterns of differing colors applied by said applicators onto a decorative face of the panel as the panel is moved through said coating stations;
a blending station located downstream of said coating stations and comprising at least one wiper, the panel conducted through the blending station, said wiper moved in a third direction other than the first direction while in sliding contact with the decorative face of the panel as the panel is moved through said blending station, the plurality of coatings applied to the panel smeared, mixed and distributed over raised portions of the panel decorative face by the wiper, by which the smeared coatings variegate the appearance of the panel decorative surface; and
a curing station through which the panel is conducted and at which the smeared coating is cured.

7. The system for decorating a siding panel of claim 6, wherein said blending station includes a plurality of said wipers that sequentially encounter a portion of the panel as it is conducted therethrough, said wipers each elongate and extending completely across the width of the panel at all times the panel is being wiped by the said wipers.

8. The system for decorating a siding panel of claim 7, further comprising first and second wipers, said first wiper upstream of said second wiper, said first wiper comprising a substantially non-absorbent, resilient pad having a surface that contacts the panel decorative face and smears the coating patterns applied thereon, whereby a variegated decorative face appearance results, said second wiper subsequently contacting the portion of the panel wiped by the first wiper, whereby the smeared coating is further smeared by the second wiper, whereby the variegated appearance is enhanced.

9. The system for decorating a siding panel of claim 8, wherein said second wiper comprises a brush having bristles that contact the panel decorative face.

10. The system for decorating a siding panel of claim 6, wherein said coating stations apply a plurality of overlapping patterns of different coatings on the panel decorative face.

11. The system for decorating a siding panel of claim 6, wherein said first direction is substantially longitudinal relative to the panel, and said second and third directions are substantially lateral relative to the panel.

12. The system for decorating a siding panel of claim 6, wherein the wipers move the applied coatings across the decorative face of the panel and into grooves therein that are substantially out of contact with at least said first wiper, whereby the grooves are substantially devoid of smeared coating.

13. A method for providing a variegated appearance on the decorative face of a siding panel, comprising the steps of:
moving the panel along a first direction sequentially through a plurality of coating stations;
applying one of a plurality of different coatings to the decorative face at each coating station with an applicator as the panel is moved along the first direction;
moving the respective applicator at each coating station in a direction different from the first direction while it is applying its coating to the decorative face, whereby different coatings are applied in a plurality of patterns on the panel;
wiping the decorative face with a first wiper that is moving in a direction different from the first direction while moving the panel in the first direction, and smearing the applied coating patterns over surfaces of a plurality of raised decorative elements of the decorative face defined by grooves therebetween, thereby variegating the coating thereon with the first wiper;
maintaining the first wiper substantially out of contact with portions of the decorative face located in the grooves, whereby coating disposed in the grooves is not smeared by the first wiper; and
curing the smeared coatings distributed on the decorative elements.

14. The method of claim 13, further comprising the step of:
wiping the decorative face with a second wiper located downstream of the first wiper prior to the step of curing and while moving the second wiper in a direction different from the first direction while moving the panel in the first direction, and further smearing the applied coating patterns over surfaces of a plurality of raised decorative elements.

15. The method of claim 14, wherein the first and second wipers are elongate and each move in directions substantially parallel to their respective longitudinal axes.

16. The method of claim 14, wherein the step(s) of wiping with at least one of the first and second wipers comprises wiping with a substantially nonabsorbent, resilient pad.

17. The method of claim 14, wherein the step of wiping with the second wiper comprises brushing the decorative surface with bristles.

18. The method of claim 13, further comprising maintaining the first and second wipers in superposition over the entire width of the panel decorative face while they are wiping.

19. The method of claim 13, wherein the directions of applicator and wiper movement directions are substantially transverse to the first direction.

20. The method of claim 13, wherein each of the applicators move together in their respective directions of movement.
